(19) United States
(12) Patent Application Publication
(10) Pub. No.: US 2018/0259107 A1
(43) Pub. Date: Sep. 13, 2018

(54) METHOD FOR PRODUCING A HOSE CONNECTOR WITH A PRESSURE GAUGE FOR A PRESSURE SENSOR

(71) Applicant: ESTA Apparatebau GmbH & Co. KG, Senden (DE)

(72) Inventors: Matthias Döppe, Langenau (DE); Andreas Klingler, Steinheim (DE); Peter Kolb, Schießen (DE)

(21) Appl. No.: 15/770,777

(22) PCT Filed: Nov. 3, 2016
(86) PCT No.: PCT/DE2016/100519

§ 371 Date: Apr. 25, 2018

(30) Foreign Application Priority Data
Nov. 6, 2015 (DE) 10 2015 119 086.9

(51) Int. Cl. F16L 41/00; F16B 19/10; F16L 41/08

(52) U.S. Cl. CPC F16L 41/008; G01L 19/0007; F16L 41/082; F16B 19/1054

(57) ABSTRACT

The invention relates to a method for producing a hose connection (1) with pressure measuring point for a pressure sensor through a closed wall (3).

The invention relates to a method for producing a hose connection with pressure measuring point for a pressure sensor through a closed wall.

With the help of an electric drive and a fan, a volumetric flow is generated in industrial extraction systems that transport dust-laden air. The air is then cleaned with the help of one or more filter elements.

To ensure an optimal operating condition of the system, the current volume flow must be measured. As practical and almost regardless of the choice of the drive, the pressure measuring point with measuring nipple has proven to be the measuring system. However, the position of the measuring nipple is given due to the mounting holes in commercially available solutions and subsequently changed only with considerable overhead, e.g. by drilling new mounting holes or by moving the nipple itself. In addition, if necessary, a new thread must be cut. The position is important, as turbulence in the blower area of the fan may influence the measuring accuracy.

The production of defined hose connections for pressure sensors involves many time-consuming steps and several parts.

From DE 10 2013 001 124 B3 a hose connection arrangement is known, in which is proposed in conjunction with a blind rivet, an additional blind rivet nut to be joined, wherein an additionally moulded hose connection is provided for connection to a hose.

The object of the invention is to provide a simplified and rational procedure for the production of a hose connection with pressure measuring point for a pressure sensor.

This object is achieved by a method for producing a hose connection for a pressure sensor according to the features of claim 1.

According to the invention, the following method steps are provided:
Making a hole through the wall with the diameter of the rivet extension of a blind rivet with mandrel,
Passing the blind rivet through the hole until the rivet head stops against the wall and inserting a hose with an inside diameter that matches the outside diameter of the rivet extension onto the rivet extension of the blind rivet on the opposite side of the wall,
Pulling the mandrel of the blind rivet.

The newly set pressure measuring point thus offers a new mounting hole and measuring nipple. At the same time, the attachment for the measuring hose is provided in a simple manner and with sufficient long-term stability in industrial applications. A particular advantage lies in the fact that already existing tool is used and no new constructions or procurements are necessary.

An embodiment of the method provides that after pulling the mandrel, the end part of the mandrel drills into the blind rivet in the direction of the attached hose. This process step is advantageous in versions of blind rivets in which a tear-off part remains after pulling.

Further advantageous embodiments will become apparent from the other dependent claims or their possible sub-combinations.

The invention will be depicted below using the drawings. In detail, the schematic representations are as follows:

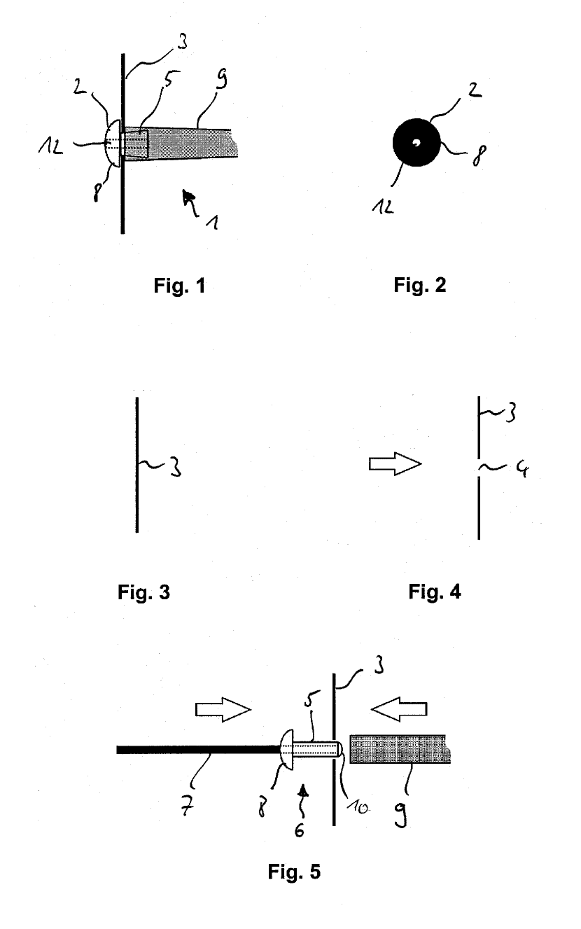

FIG. 1 is a schematic representation of a hose connection produced by the method according to the invention,

FIG. 2 is a view of the head of the blind rivet in the air-flow area of the inlet nozzle,

FIGS. 3 to 8 represent the individual steps of the process, and

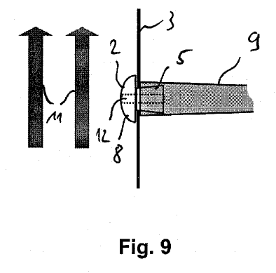

FIG. 9 a schematic representation of a hose connection produced by the process according to the invention with pressure measuring point during operation.

The same reference numerals in the figures designate the same or equivalent elements.

FIG. 1 is a schematic representation of a hose connection 1 produced in the wall 3 of the inlet nozzle according to the invention shown. FIG. 2 schematically shows the top view of the rivet head 8. The arrangement builds up the pressure measuring point.

The area of the rivet extension 5, which is thickened by the pull of the mandrel of the blind rivet, clamps the previously plugged-on area of the tube 9 securely and firmly.

The rivet head 8 of the blind rivet is located in the air-flow area of the inlet nozzle. The air duct 12 through the blind rivet head forms a connection to the hose 9. The pressure sensor can be connected to said hose (not shown).

FIGS. 3 to 8 show the process according to the invention in individual steps.

FIG. 3 shows the wall 3 to be penetrated for the sensor/hose connection.

FIG. 4 shows the production of a hole 4 through the wall 3 with the diameter of the rivet extension 5 of a blind rivet 6 with mandrel 7, illustrated by the arrow.

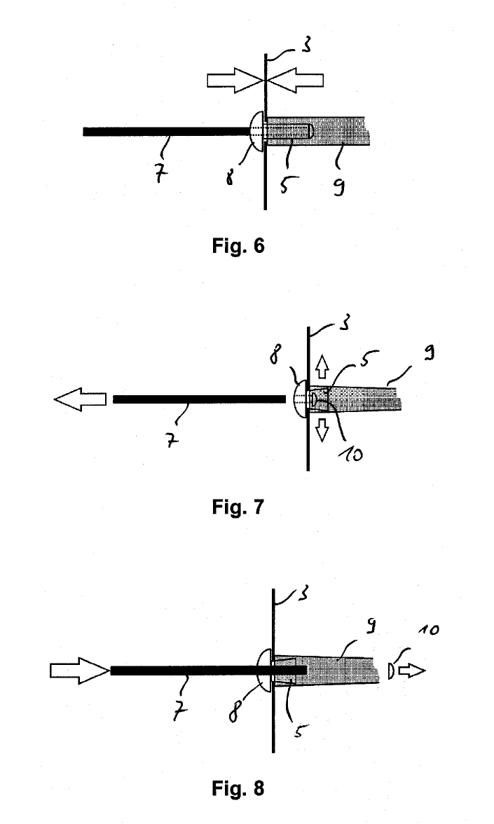

FIG. 5 shows the insertion of the blind rivet 6 through the hole 4 until it stops—see also FIG. 6—of the rivet head 8 on the wall 3 and attaching a tube 9 having an inner diameter of the outer diameter of the blind rivet extension 5 corresponds to the blind rivet extension 5 of the blind rivet 6 on the opposite side of the wall 3.

FIG. 7 shows the pulling of the mandrel 7 of the blind rivet 6 in the direction of the arrow, by tearing off the end part 10 of the mandrel 7. The pulling can be done with a normal blind rivet. The blind rivet extension 5 can expand in the region of the attached hose 9. The termination part 10 of the blind rivet may optionally remain in the widened region of the rivet after tearing off the mandrel 7 and must then be removed therefrom.

Finally, as shown in FIG. 8, only the end part 10 of the mandrel 7 drills into the blind rivet 6 in the direction of the attached hose 9. For this, e.g. also the mandrel 7 previously torn off with the help of the rivet plunger can be used together with light hammer blows.

After removal of the end part 10 from the hose 9, the hose connection is completed by the wall 3 of the inlet nozzle for a pressure sensor. After completion of the work, the rivet head 8 aerodynamically protruding remains in the air-flow area. The attached hose 9 holds without glue or other attachment measures.

FIG. 9 shows the hose connection 1 with rivet head 8 during operation for measuring an air flow 11 through the air duct 12 and the hose 9.

### LIST OF REFERENCE SIGNS

1 Hose connection
2 Pressure measuring point
3 Wall
4 Hole
5 Rivet extension
6 Blind rivet
7 Mandrel
8 Rivet head
9 Hose
10 End part
11 Air flow
12 Air channel

1. A method for producing a hose connection with pressure measuring point for a pressure sensor through a closed wall,
comprising the following steps:
Making a hole through the wall with the diameter of the rivet extension of a blind rivet with mandrel,
Passing the blind rivet through the hole until the rivet head stops against the wall and inserting a hose with an inside diameter that matches the outside diameter of the rivet extension onto the rivet extension of the blind rivet on the opposite side of the wall,
Pulling the mandrel of the blind rivet.

2. The method of claim 1,
wherein after pulling the mandrel, the end part of the mandrel drills into the blind rivet in the direction of the attached hose.
